(19) United States
(12) Patent Application Publication
(10) Pub. No.: US 2019/0099847 A1
(43) Pub. Date: Apr. 4, 2019

(54) STRUCTURE FOR CLEANING GLASS DEBRIS AND TRANSPORTER

(71) Applicants: HKC CORPORATION LIMITED, Shenzhen City (CN); CHONGQING HKC IPTOELECTRONICS TECHNOLOGY CO., LTD, JIESHI, BANAN DISTRICT (CN)

(72) Inventor: Jie RAN, Jieshi, Banan District (CN)

(73) Assignees: HKC CORPORATION LIMITED, Shenzhen City (CN); CHONGQING HKC OPTOELECTRONICS TECHNOLOGY CO, LTD., JIESHI,M BANAN DISTRICT (CN)

(21) Appl. No.: 15/745,390

(22) PCT Filed: Aug. 31, 2017
(86) PCT No.: PCT/CN2017/100030

§ 371 Date: Jan. 16, 2018

(30) Foreign Application Priority Data
Dec. 12, 2016 (CN) 201611141704.6

(51) Int. Cl. B23Q 11/00; B28D 7/02

(52) U.S. Cl. CPC B23Q 11/006; B23Q 11/0075; B28D 7/02

(57) ABSTRACT

A structure for cleaning glass debris and a transporter are provided. The structure includes: a platform and an air cutter arranged at a side of the platform. A minimum angle between the air cutter and a horizontal plane of the platform is less than 90 degrees.

### TECHNICAL FIELD

The present disclosure relates to a structure for cleaning glass debris and a transporter.

### BACKGROUND

In the related manufacturing process of glass substrates, when the glass substrate is cut by a wheel cutter of a veneer-cutting machine, a large amount of fine glass debris residue is generated and enters an alignment ultraviolet irradiation platform along with the glass substrate. A portion of the alignment ultraviolet irradiation platform in contact with the glass substrate is coated with a black fluororesin, playing a role in temperature conduction and ultraviolet absorption.

After the glass debris enters the alignment ultraviolet irradiation platform, a coating layer of the platform is liable to be scrapped, and a metal inner panel is exposed, causing the ultraviolet light to be reflected during manufacturing. As a result, bad alignments in single dots or small regions are formed on the substrate, and the yield is low.

### SUMMARY

One of the objects of the present disclosure is to provide a structure for cleaning glass debris, which is capable of removing glass debris timely and improving the yield.

In a first aspect, the present disclosure provides a structure for cleaning glass debris, including:

a wheel cutter of a veneer-cutting machine; a platform for arranging a transparent substrate; and an air cutter arranged at one side of the platform. The air cutter includes an air outlet. A minimum angle between the air outlet and a horizontal plane of the platform is less than 90 degrees.

In a second aspect, a transporter is provided. The transporter includes a structure for cleaning glass debris of the transporter and a transport mechanism for transporting the transparent substrate. The structure includes a wheel cutter of a veneer-cutting machine; a platform for arranging a transparent substrate; and an air cutter arranged at one side of the platform. The air cutter includes an air outlet. A minimum angle between the air outlet and a horizontal plane of the platform is less than 90 degrees.

In a third aspect, there is provided a glass substrate cutting device, including:

a platform, for disposing a glass substrate;

a wheel cutter, for cutting the glass substrate; and

a first air cutter and a second air cutter.

An air outlet of the first air cutter is configured to face the glass substrate at a first angle, and an air outlet of the second air cutter is configured to face the glass substrate at a second angle. An angle between the air outlet of the first air cutter and a surface of the platform is less than 90 degrees, and an angle between the air outlet of the second air cutter and the surface of the platform is less than 90 degrees.

It will be understood by those of ordinary skill in the art that although the following detailed description will be made with reference to the illustrated embodiments and the accompanying drawings, the present disclosure is not limited to these embodiments. Nevertheless, the scope of the disclosure is broad and the scope of the present disclosure is intended to be limited by the appended claims.

### BRIEF DESCRIPTION OF DRAWINGS

Other features, objects, and advantages of the present disclosure will become apparent by reading the following detailed description of the non-limiting embodiments with reference to the following drawings:

FIG. 1 is a schematic view of a transporter.

FIG. 2 is a schematic view of a structure for cleaning glass debris provided according to an embodiment of the present disclosure.

FIG. 3 is a schematic view of a structure of an air cutter provided according to an embodiment of the present disclosure.

FIG. 4 is a schematic showing a connection between an air cutter and a roller provided according to an embodiment of the present disclosure.

### DETAILED DESCRIPTION

Before discussing the exemplary embodiments in more detail, it should be noted that some exemplary embodiments are described as processes or methods depicted in the flowcharts. Although the flowcharts describe the operations as sequential processing, many of these operations may be implemented in parallel, concurrently, or simultaneously. In addition, the order of operations can be rearranged. A process may be terminated when its operations are complete, but the process may also have additional steps not included in the drawings. The process may correspond to a method, a function, a procedure, a subroutine, a sub-procedure, or the like.

The methods discussed below (some of which are depicted by flow charts) may be implemented by hardware, software, firmware, middleware, microcode, hardware description language, or any combination thereof. When a method is implemented by software, firmware, middleware, or microcode, the program code or code segment for implementing the necessary task may be stored in a machine or a computer-readable medium (e.g. a storage medium). (One or more) processors can perform the necessary task.

The specific structures and functional details disclosed herein are merely representative and are intended to describe the exemplary embodiments of the present disclosure. However, the disclosure may be specifically embodied in many alternative forms and is not to be construed as limited to the embodiments set forth herein.

It should be understood that although the terms “first”, “second” and the like may be used herein to describe each unit, these units should not be limited by these terms. The use of these terms is only to distinguish one unit from another. For example, without departing from the scope of the exemplary embodiment, the first unit may be referred to as a second unit, and similarly a second unit may be referred to as a first unit. The term “and/or” as used herein includes any and all combinations of one or more of the associated items listed therein.

The terminology used herein is merely for the purpose of describing particular embodiments only and is not intended to limit the exemplary embodiments. Unless otherwise clearly indicated in the context, the singular forms “a” and “an” as used herein, are also intended to include the plural. It should also be understood that the terms “comprising” and/or “including” used herein, specify the presence of stated features, integers, steps, operations, units and/or components without excluding the presence or addition of one or more other features, integers, steps, operations, units, components and/or a combination thereof.

It should also be mentioned that in some alternative implementations, the mentioned functions/actions may occur in an order different from that indicated in the drawings. For example, two pictures shown in succession may actually be executed substantially simultaneously or sometimes in the reverse order depending on the function/action involved.

As shown in FIG. 1, which is a schematic view of a structure of a transporter, the transporter is used in a process of manufacturing a liquid crystal panel, specifically, is used in a cutting process of a transparent substrate (glass panel) on a surface of the liquid crystal panel. The transporter includes a veneer-cutting machine and a platform. A glass product is disposed on the platform. The veneer-cutting machine is used to cut the glass product disposed on the platform. When the veneer-cutting machine is cutting the glass product, a large amount of glass debris is generated and enters the platform. And thus when the glass product is moving in the platform, the glass debris causes friction between the glass product and the platform, which causes the platform to be worn by glass debris, the metal inner panel to be exposed, and the ultraviolet light to be reflected during manufacturing. As a result, bad alignments in single dots or small regions are formed on the substrate, and the yield is low.

The present disclosure is further described below with reference to accompanying figures.

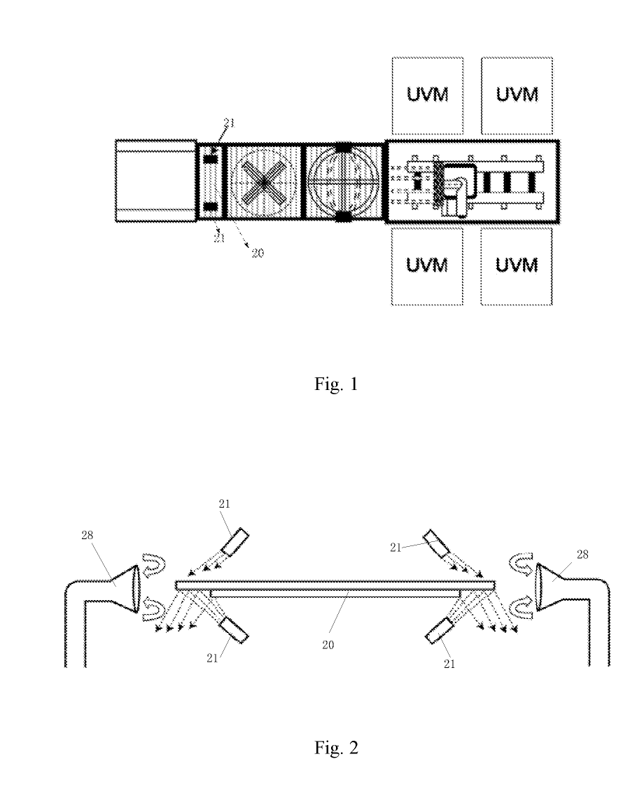

According to an aspect of the present disclosure, a structure for cleaning glass debris is provided. As shown in FIG. 2, the structure for cleaning glass debris includes: a wheel cutter 29 of a cutting machine, a platform 20 and an air cutter 21 arranged at one side of the platform 20. The air cutter 21 includes an air outlet 218. A minimum angle between the air outlet 218 and a surface of the platform 20 is less than 90 degrees. The platform 20 is used to dispose a transparent substrate. In a technical solution provided by an aspect of the present disclosure, the air cutter is arranged at one side of the platform 20, and the air cutter is arranged to form an angle with respect to the platform 20. As shown in FIG. 2, the air flow provided by the air cutter blows away the glass debris generated when the glass is cut by the veneer-cutting machine, ensuring that the glass products is clean. Therefore, the structure has advantages in removing glass debris and improving the product yield.

Optionally, the above air cutter 21 is multiple air cutters. The multiple air cutters are arranged at a first side and a second side opposite to the first side of the platform 20 separately. In the present embodiment, the multiple air cutters are arranged at a left side and a right side of the platform 20 separately. It can improve the effect of the air cutters by arranging the air cutters at two side faces. The air flow provided by the air cutter at the left side and the air flow provided by the air cutter at the right side can well clean the glass debris on the surfaces of the glass product, especially in the case of large size glass product.

Optionally, the air cutter 21 is multiple air cutters. The multiple air cutters are arranged at an upper side and a lower side of the platform separately.

The glass debris on the upper side and the lower side of the glass product can be handled effectively by arranging the air cutters on both the upper side and the lower side face.

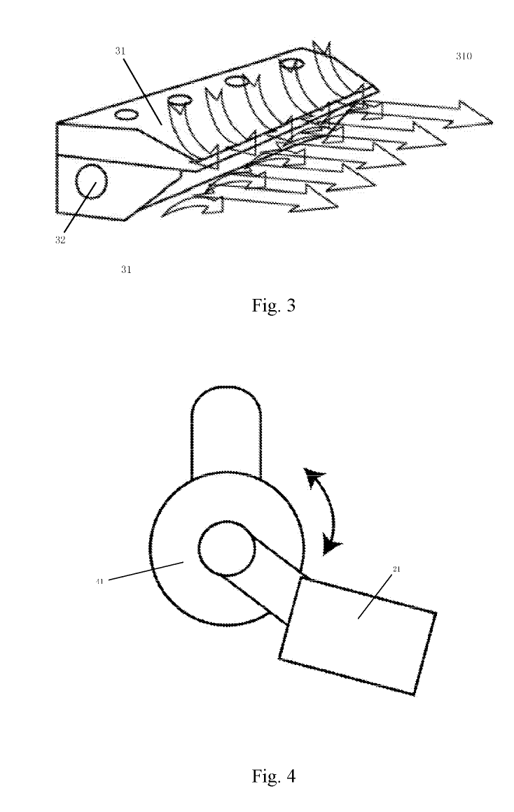

Optionally, as shown in FIG. 3, the air cutter includes an air guide platform 31 and a support part 32. The air guide platform 31 is in a slope shape, an opening 310 is arranged at a bottom of the air guide platform 31, and the opening serves as the air outlet of the air cutter. The support part 32 is provided with a connection part 321, and the connection part 321 is connected to a roller 41 (the specific connection structure is depicted in FIG. 4).

The structure of the above air cutter is provided with a slope, such that the air flow may be blow in from a top end of the slope and guided into the platform along the slope. The support part first plays a role in supporting the air guide platform. Furthermore, the support part is provided with the connection part, and the connection part is connected to the roller such that the angle between the air cutter and the platform can be adjusted according to the actual situation, thereby achieving the optimum blowing effect and improving the cleanliness of glass product.

Optionally, the structure for cleaning glass debris further includes an air suction device 28. The air suction device 28 is arranged at one side of the platform. A bottom of the air suction device 28 may be further provided with a dust collection box. So it is convenient to collect the glass debris and the cleanliness of glass product is further improved.

Another aspect of the present disclosure provides a transporter. The transporter includes the above structure for cleaning glass debris and a transport mechanism for transporting a transparent substrate. The transport includes, but is not limited to, the following manners: roller, robotic arm, moving, conveying, lifting, and the like.

Finally, it should be noted that the above embodiments are merely for illustrating the technical solutions of the present disclosure and are not intended to limit them. Although the present disclosure has been described in detail with reference to the foregoing embodiments, it will be understood by those of ordinary skill in the art that it is still possible to modify the technical solutions described in the foregoing embodiments or to equivalently substitute some or all of the technical features therein. These modifications or substitutions do not cause the essential of the corresponding technical solutions to depart from the scope of the technical solutions of the disclosed embodiments, and should be included within the scope of the claims and the specification of the present disclosure.

What is claimed is:

1. A structure for cleaning glass debris, comprising:
a wheel cutter of a cutting machine;
a platform for arranging a transparent substrate; and
an air cutter,
wherein the air cutter comprises an air outlet, and the air outlet is configured to face the tranparent substrate, and an angle between the air outlet and a surface of the platform is less than 90 degrees.

2. The structure for cleaning glass debris of claim 1, wherein the air cutter comprises a first air cutter and a second air cutter, the first air cutter is arranged at a first side of the platform, and the second air cutter is arranged at a second side of the platform opposite to the first side.

3. The structure for cleaning glass debris of claim 2, wherein the first air cutter is arranged at a upper side of the platform and the second air cutter is arranged at a lower side of the platform.

4. The structure for cleaning glass debris of claim 1, further comprising: a roller,
wherein the air cutter comprises: a air guide platform and a support part, and the air guide platform is in a slope shape, the air outlet is arranged at a bottom of the air guide platform, the support part is provided with a connection part, and the connection part is connected to the roller.

5. The structure for cleaning glass debris of claim 2, further comprising: a roller,
wherein the air cutter comprises: a air guide platform and a support part, and
the air guide platform is in a slope shape, the air outlet is arranged at a bottom of the air guide platform, the support part is provided with a connection part, and the connection part is connected to the roller.

6. The structure for cleaning glass debris of claim 3, further comprising: a roller,
wherein the air cutter comprises: a air guide platform and a support part, and
the air guide platform is in a slope shape, the air outlet is arranged at a bottom of the air guide platform;
the support part is provided with a connection part, and the connection part is connected to the roller.

7. The structure for cleaning glass debris of claim 1, further comprising an air suction device disposed at one side of the platform.

8. The structure for cleaning glass debris of claim 2, further comprising an air suction device disposed at one side of the platform.

9. The structure for cleaning glass debris of claim 3, further comprising an air suction device disposed at one side of the platform.

10. A transporter, comprising:
a transport mechanism configured to transport a transparent substrate; and
a structure for cleaning glass debris,
wherein the structure comprises:
a wheel cutter of a cutting machine,
a platform for arranging the transparent substrate; and
an air cutter, wherein the air cutter comprises an air outlet, the air outlet is configured to face the transparent substrate, and an angle between the air outlet and a surface of the platform is less than 90 degrees.

11. The transporter of claim 10, wherein the air cutter comprises a first air cutter and a second air cutter, the first air cutter is arranged at a first side of the platform, and the second air cutter is arranged at a second side of the platform opposite to the first side.

12. The transporter of claim 11, wherein the first air cutter is arranged at a upper side of the platform and the second air cutter is arranged at a lower side of the platform.

13. The transporter of claim 10, further comprising: a roller,
wherein the air cutter comprises: a air guide platform and a support part, and
wherein the air guide platform is in a slope shape, the air outlet is arranged at a bottom of the air guide platform, the support part is provided with a connection part, and the connection part is connected to the roller.

14. The transporter of claim 11, further comprising: a roller,
wherein the air cutter comprises: a air guide platform and a support part,
and wherein the air guide platform is in a slope shape, the air outlet is arranged at a bottom of the air guide platform, the support part is provided with a connection part, and the connection part is connected to the roller.

15. The transporter of claim 12, further comprising: a roller,
wherein the air cutter comprises: a air guide platform and a support part,
and wherein the air guide platform is in a slope shape, the air outlet is arranged at a bottom of the air guide platform, the support part is provided with a connection part, and the connection part is connected to the roller.

16. The transporter of claim 10, further comprising an air suction device disposed at a side of the platform.

17. The transporter of claim 11, further comprising an air suction device disposed at a side of the platform.

18. The transporter of claim 12, further comprising an air suction device disposed at a side of the platform.

19. A glass substrate cutting device, comprising:
a platform for arranging a glass substrate;
a wheel cutter for cutting the glass substrate; and
a first air cutter and a second air cutter,
wherein an air outlet of the first air cutter is configured to face the glass substrate at a first angle, and an air outlet of the second air cutter is configured to face the glass substrate at a second angle, an angle between the air outlet of the first air cutter and a surface of the platform is less than 90 degrees, and an angle between the air outlet of the second air cutter and the surface of the platform is less than 90 degrees.

20. The glass substrate cutting device of claim 19, wherein the first angle is not equal to the second angle, and the air outlet of the first air cutter and the air outlet of the second air cutter aim at a same position.
